(19) United States
(12) Patent Application Publication
(10) Pub. No.: US 2016/0177680 A1
(43) Pub. Date: Jun. 23, 2016

(54) SUBSEA DIELECTRIC FLUID INJECTION TOOL

(71) Applicants: Jonathan Hatcher, South Daytona, FL (US); Seth Grablow, Palm City, FL (US); Alan McCleary, Saint Augustine, FL (US)

(72) Inventors: Jonathan Hatcher, South Daytona, FL (US); Seth Grablow, Palm City, FL (US); Alan McCleary, Saint Augustine, FL (US)

(73) Assignee: TELEDYNE INSTRUMENTS, INC., Thousand Oaks, CA (US)

(21) Appl. No.: 14/581,870

(22) Filed: Dec. 23, 2014

(51) Int. Cl. E21B 41/04; H01R 13/523; H01R 13/52; E21B 33/038

(52) U.S. Cl. CPC E21B 41/04; E21B 33/0385; H01R 13/523; H01R 13/5202

(57) ABSTRACT

The present invention generally relates to a repair tool having a piston-style, syringe-like dielectric grease injection system within a plug body configured to inject dielectric grease into the receptacle pin of damaged subsea electrical connectors. The tool is mateable via ROV (or hand/diver/stab) and features separate mate/grease actuation mechanisms. The tool features standard mating interfaces and has a termination shell that contains dielectric grease and secondary grease injection/actuation mechanism. The dielectric grease is injected into damaged subsea receptacles, preventing or mitigating subsea electrical shorts.

### FIELD OF THE INVENTION

The present invention generally relates to subsea connector assemblies and more particularly to field deployable devices for repairing damaged connectors.

### BACKGROUND OF THE INVENTION

In various undersea operations, especially in connection with undersea oil or gas wells, mining, exploration and military applications, operational and monitoring equipment requires electrical and/or optical connections to various equipment. Such equipment can for instance be a power supply, a flow meter for monitoring the flow of hydrocarbons in a pipe, a temperature gauge, a pressure gauge, etc. Such connections may also be needed in order to actively control equipment such as valves, or control devices such as microcontrollers.

In offshore drilling and production operations, equipment are often subjected to harsh conditions thousands of feet under the sea surface with working temperatures of −50° F. to 350° F. with pressures of up to 15,000 psi. Subsea control and monitoring equipment commonly are used in connection with operations concerning the flow of fluid, typically oil or gas, out of a well. Flow lines are connected between subsea wells and production facilities, such as a floating platform or a storage ship or barge. Subsea equipment include sensors and monitoring devices (such as pressure, temperature, corrosion, erosion, sand detection, flow rate, flow composition, valve and choke position feedback), and additional connection points for devices such as down hole pressure and temperature transducers. A typical power supply provides power to the undersea equipment and the control system monitors, measures, and responds based on sensor inputs and outputs control signals to control subsea devices. For example, a control system attached to a subsea tree controls down-hole safety valves. Functional and operational requirements of subsea equipment have become increasingly complex along with the sensing and monitoring equipment and control systems used to insure proper operation.

To connect the numerous and various power, sensing, monitoring and control equipment necessary to operate subsea equipment, harsh-environment connectors are used with electrical cables, optical fiber cables, or hybrid electro-optical cables. Initial demand for subsea connector development was in connection with military applications. Over time demand for such connectors has grown in connection with offshore oil industry applications.

Submersible electrical connectors may be of the dry-mate type or the wet-mate type. Dry-mate connectors cannot be mated while underwater, but rather must be mated before they are submerged. Wet-mate connectors can be mated and demated while underwater. Wet-mate connectors may use a simple interference-fit sealing mechanism that includes elastomeric seals. The elastomeric seats substantially force the water out of the contact area and seal the contact area from the outside environment. Other wet-mate connectors may use a dielectric fluid-filled chamber. The chamber, which is in the female or receptacle side of the connector, is penetrated by plug pins having insulated shafts, which are in the plug or male side of the connector. The purpose of these sealed, fluid-filled connectors is to insulate the electrical junctions from the outside environment by enclosing them within a chamber, or chambers, of dielectric fluid. These fluid-filled connectors offer many advantages over the other types. They are spark-proof, and therefore can be mated and de-mated with the receptacle electrically energized. However, it is unadvisable to mate or de-mate energized connectors. Power-on mating or de-mating may cause damage to sealing components in the connectors. The connectors include the additional safety feature that if the connector plug is inadvertently disconnected from the receptacle while the receptacle is energized, or if a circuit is accidentally energized in the unmated condition, they remain “dead-faced” to the outside environment, preventing short circuits. A large body of existing art is exemplified by U.S. Pat. Nos. 5,772,457, 5,194,012 and 4,948,377, issued to Cairns; U.S. Pat. No. 4,795,359, issued to Alcock; and U.S. Pat. No. 4,039,242, issued to Wilson.

Early underwater connectors were electrical “dry-mate” devices, intended to be mated prior to immersion in the sea and were of two principal types: rubber-molded “interference fit” type and rigid-shell connectors. The rubber molded “interference-fit” connectors depended on receptacles with elastic bores that stretched and sealed over mating plugs. The rigid-shell connectors had mating parts sealed together via O-rings or other annular seals.

Ocean Design, Inc. has been an industry leader in the development of subsea connectors and applications. Dr. James Cairns' article Hybrid Wet-Mate Connectors: ‘Writing the Next Chapter’, Sea Technology, published July 1997, provides a thorough discussion of the history of underwater connectors through to 1997, and is a source for this background summary. In the early 1960s, electrical connectors intended for mating and de-mating underwater came into use. These so called “wet-mate” connectors were adaptations of the interference-fit dry-mate versions, and were designed so that when mated, the water contained in the receptacle bores would be substantially expelled prior to sealing. Also during this time, the first oil-filled and pressure-balanced electrical connector designs were introduced. These isolated the receptacle contacts within sealed oil-chambers which, during engagement, were penetrated by elongated pins with insulated shafts. Connection was, therefore, accomplished in the benign oil, not in harsh seawater. Unlike previous connector types which could not be disengaged at even modest depths, pressure balancing type connectors could be actuated anywhere in the sea. These wet-mate oil-filled connectors eventually became the high-reliability standard for the offshore oil industry. One critical design element of oil-filled connectors is providing seals that allow the oil chambers to be penetrated repeatedly without losing the oil or allowing seawater intrusion. One design widely used for electrical applications accomplishes this through the use of dielectric pistons, one of which resides in each receptacle socket. Each piston has a spring which biases it outward to automatically fill the socket's end-seal when the plug pin is withdrawn. During mating the pins push these pistons back through the oil-chamber ports (which they have kept sealed) and onward deep inside the sockets.

Early subsea wet-mate optical connectors passed only one optical circuit and used expanded-beam lenses or fiber-to-fiber physical contact junctions. To protect the optical interfaces, both the plug and receptacle contacts were housed in oil-filled chambers which were pressure balanced to the environment. Problems with this design included that sealing and cleanliness were not adequate to provide desired reliability. The spring/piston concept used for sealing electrical connectors is not effective for optical connectors as pistons get in the way of the light path. A second type of subsea-mateable optical connector consisted basically of dry-mate connectors which had a bit of optical index-matching gel placed in the contact interfaces. The excess gel was expelled upon mating. There was no attempt to exclude sand or silt from the interfaces, and the resulting performance was left to chance. Hybrid wet-mate devices were an attempt to combine oil-filled and pressure-balanced plug and receptacle housings with means for sealing and maintaining cleanliness of the optical interfaces. Within both, plug and receptacle, oil chambers, groups of contact junctions are aligned behind cylindrical rubber face-seals. When mated, opposed plug and receptacle seals first press against each other like the wringers of an old-fashioned washing machine, forcing the water out from between them. As the mating sequence continues the opposed plug and receptacle seals, like the wringers, roll in unison and transport any debris trapped between them off to the side. The action simultaneously causes clean, sealed, oil-filled passages to open between opposed plug and receptacle contact junctions. Continuing the mating process, plug pins advance through the sealed passages to contact sockets within the receptacle. De-mating is the reverse sequence. In the case of electrical circuits each mated pin/socket junction is contained in an individual, secondary, sealed oil chamber within the common oil volume. The contacts are unexposed to environmental conditions before, during and after mating.

There are many types of connectors for making electrical and fiber-optic cable connections in hostile or harsh environments, such as undersea or submersible connectors which can be repeatedly mated and de-mated underwater at great ocean depths. Current underwater connectors typically comprise releasably mateable plug and receptacle units, each containing one or more electrical or optical contacts or junctions for engagement with the junctions in the other unit when the two units are mated together. Each of the plug and receptacle units or connector parts is attached to cables or other devices intended to be joined by the connectors to form completed circuits. To completely isolate the contacts to be joined from the ambient environment, one or both halves of these connectors house the contacts in oil-filled, pressure-balanced chambers—this is referred to as a pressure balanced set-up. Such devices are often referred to as “wet-mate” devices and often are at such great depths that temperature and other environmental factors present extreme conditions for materials used in such devices. The contacts on one side (plug) are in the form of pins or probes, while the contacts or junctions on the other side (receptacle) are in the form of sockets for receiving the probes.

Typically, the socket contacts are contained in a sealed chamber containing a dielectric fluid or other mobile substance, and the probes enter the chamber via one or more sealed openings. Such wet-mate devices have previously been pressure compensated. One major problem in designing such pressure compensated or pressure balanced units is the performance and longevity of seals required to exclude seawater and/or contaminates from the contact chamber after repeated mating and de-mating.

In some known underwater electrical connectors, such as that described in U.S. Pat. No. 4,795,359 of Alcock and U.S. Pat. No. 5,194,012 of Cairns, tubular socket contacts are provided in the receptacle unit, and spring-biased pistons are urged into sealing engagement with the open ends of the socket assemblies. As the plug and receptacle units are mated, pins on the plug portion urge the pistons back past the contact bands in the sockets, so that electrical contact is made.

Thus, common underwater connectors comprise releasably, mateable plug and receptacle units, each containing one or more electrical contacts or junctions for engagement with the junctions in the other unit when the two units are mated together. The contacts on one side are in the form of pins or probes, while the contacts or junctions on the other side are in the form of sockets for receiving the probes. Typically, the socket contacts are contained in a sealed chamber containing a dielectric fluid or other mobile substance, and the probes enter the chamber via one or more sealed openings. One major problem in designing such units is the provision of seals which will adequately exclude or evacuate seawater and/or contaminants from the contact chamber after repeated mating and de-mating operations.

Another problem associated with mating and de-mating operations is that arcs may occur resulting in damage to the receptacle connector terminals and surrounding structure. Such damage may lead to two or more circuits being open, creating an electrical short when seawater intrusion occurs and due to the electrical arcing. A damaged receptacle may cause a breaker or like device to prevent further operation involving the affected circuit and connector. In remote undersea locations the cost to correct and to repair or replace a damaged receptacle/connector may be great. The cost of sending a diver (if possible) or a remote operated vehicle (ROV) to repair the damaged connector is great. A damaged receptacle typically cannot be repaired subsea. To repair a damaged assembly, any connections on the umbilical termination assembly (UTA), or other subsea assembly to which the receptacle is attached, must be disconnected and the subsea assembly must be brought to the surface for repairs. After repairs, the assembly may be reinstalled subsea. The process of bringing an assembly to the surface for repairs is time consuming and costly. What is needed is a repair tool capable of mating with and correcting damaged subsea receptacle connectors to allow operation to continue or to at least correct or mitigate the effects of the damaged connector.

More particularly, typical receptacle designs provide redundancy such that if one or two circuits fail in a receptacle then circuits internal to the receptacle may be switched remotely to allow operation to continue by way of a redundant circuit. However, even with redundancy when an arc occurs or other short circuits occur a breaker may prevent operation. Accordingly, what is needed is a tool that can remediate the damage to the connector to fix the shorted condition and to allow operation to continue.

### SUMMARY OF THE INVENTION

The present invention provides a delivery system for injecting dielectric fluid, such as dielectric grease, into the receptacle pins to prevent or mitigate against electrical shorts in damaged receptacles. The invention is field deployable and capable of being custom configured with a combination of grease injector pins and dummy pins to match and mate with receptacle pins in need of repair and for alignment purposes in mating of the repair plug tool and damaged receptacle. While the invention is described herein principally in connection with use of dielectric grease, it would be understood that the use of any suitable dielectric fluid capable of injection and displacement of seawater is fully contemplated by the invention. The repair tool of the invention saves a significant amount of time and money by allowing users to leave connectors/equipment subsea for damage mitigation.

In one manner the repair tool is designed with a piston-style, syringe-like grease injection system within the termination shell of the assembly that can be configured to inject dielectric grease into the receptacle pin of damaged subsea electrical connectors. The tool is mateable via ROV (or hand/diver/stab) and features separate mate/grease actuation mechanisms. The tool features standard mating interfaces and has a termination shell that contains dielectric grease and secondary grease injection/actuation mechanism. The dielectric grease is injected into damaged subsea receptacles, preventing or mitigating subsea electrical shorts.

In one embodiment, the present invention may comprise a field deployable connector repair device for mating with a damaged undersea connector, the connector repair device comprising: a plug unit having a cylindrical body, a rear end and a front end adapted for mating engagement with a damaged receptacle unit when aligned with a plug receiving end of the damaged receptacle unit, the plug body housing a set of at least one fluid injection pin and a set of at least one fluid plunger configured in receiving alignment with the set of at least one injection pin and mounted to a piston, the piston being slidably mounted in the plug unit body, a spring actuation mechanism adapted to actuate the piston from a pre-deployed position to a deployed position and to propel the piston forward from the rear end toward the front end of the plug unit and propel the set of at least one plunger to force dielectric fluid through and out of the set of at least one fluid injection pin; and an alignment means for aligning the plug unit with the damaged receptacle such that the set of at least one injector pin is disposed opposite a set of at least one pin receptacle contained in the damaged receptacle unit in a desired manner, whereby upon mating the plug unit with the damaged receptacle unit and upon actuating the spring actuation mechanism the set of at least one injection pin is received into the set of at least one pin receptacle, the piston acts on the set of at least one plunger and the dielectric fluid is injected through the set of at least one fluid injection pin and into the set of at least one pin receptacle contained in the damaged receptacle unit; and a locking mechanism adapted to lock the plug in a mated position with the damaged receptacle unit.

The above embodiment may further comprise wherein the connector repair device of further comprises a cylindrically-shaped slide member partially surrounding the plug body and the set of at least one fluid injection pin and having a slide collar at an end distal to the plug rear end, the slide collar being configured to facilitate bringing the plug unit into alignment and engagement with the damaged receptacle unit during the mating process. The connector repair device may further comprise a means for deploying the spring actuation means external to the plug unit. The means for deploying the spring actuation means may be a shackle device having a pin connected to an external release mechanism. The connector repair device may further comprise a set of at least one dummy pin. The connector repair device may further comprise a plug pin assembly end adapted to fix the set of at least one fluid injection pin and the set of at least one dummy pin in a defined pattern, and a means for releasably mounting the set of at least one fluid injection pin and the set of at least one dummy pin within the plug unit. The set of at least one fluid injection pin each may include a body having at least one opening through which the dielectric fluid exits the body when a plunger is acted on by the piston. The locking mechanism may further be adapted to lock the plug in a mated position with the damaged receptacle unit and to release the plug from the damaged receptacle in a de-mating operation. The set of at least one plunger may include a seal to prevent leakage of the dielectric fluid upon actuation. The connector repair device may further comprise a terminal tube portion disposed intermediate each respective set of at least one fluid injection pin and set of at least one plunger, and which contains the dielectric fluid.

In another embodiment, the present invention may comprise a field deployable connector repair device for mating with a damaged undersea connector, the connector repair device comprising: a plug unit having a body, a rear end and a front end adapted for mating engagement with a damaged receptacle unit when aligned with a plug receiving end of the damaged receptacle unit, the plug body housing a first fluid injection pin and a first fluid plunger associated with the first fluid injection pin and mounted to a piston, the piston being movably mounted in the plug unit body, a means to maintain the first plunger in a pre-deployed position, and an actuation mechanism adapted to actuate the piston from the pre-deployed position to a deployed position and to propel the piston forward from the rear end toward the front end of the plug unit and propel the first plunger to force dielectric fluid through and out of the first fluid injection pin; and an alignment means for aligning the plug unit with the damaged receptacle such that the first fluid injector pin is disposed opposite a first pin receptacle in the damaged receptacle unit in a desired manner, whereby upon mating the plug unit with the damaged receptacle unit and upon actuating the actuation mechanism the first injection pin is received into the first pin receptacle, the piston acts on the first plunger and the dielectric fluid is injected through the first fluid injection pin and into the first pin receptacle contained in the damaged receptacle unit; and means for releasably locking the plug in a mated position with the damaged receptacle unit.

The above embodiment may further comprise wherein the connector repair device further comprises a cylindrically-shaped slide member partially surrounding the plug body and the first fluid injection pin and having a slide collar at an end distal to the plug rear end, the slide collar being configured to facilitate bringing the plug unit into alignment and engagement with the damaged receptacle unit during the mating process. The connector repair device may further comprise a means for deploying the spring actuation means external to the plug unit. The means for deploying the spring actuation means may be a shackle device having a pin connected to an external release mechanism. The connector repair device may further comprise a first dummy pin. The connector repair device may further comprise a plug pin assembly end adapted to fix the first fluid injection pin and the first dummy pin in a defined pattern, and a means for releasably mounting the first fluid injection pin and the first dummy pin within the plug unit. The first fluid injection pin may include a body having at least one opening through which the dielectric fluid exits the body when the first plunger is acted on by the piston. The locking mechanism may further be adapted to lock the plug in a mated position with the damaged receptacle unit and to release the plug from the damaged receptacle in a de-mating operation. The first plunger may include a seal to prevent leakage of the dielectric fluid upon actuation. The connector repair device may further comprise a first terminal tube portion disposed intermediate the first fluid injection pin and the first plunger, and which contains the dielectric fluid.

### BRIEF DESCRIPTION OF THE DRAWINGS

In order to facilitate a complete understanding of the present invention, this system, and the terms used, reference is now made to the accompanying drawings, in which like elements are referenced with like numerals. These drawings should not be construed as limiting the present invention or system, but are exemplary and for reference.

FIG. 1 provides a perspective view of an embodiment of the capping tool according to the present invention;

FIG. 2 provides a lateral partial cross-section view of an embodiment of the capping tool according to the present invention;

FIG. 3 provides a front view of an embodiment of the capping tool according to the present invention;

FIG. 4 provides a detailed front view of an embodiment of the capping tool according to the present invention;

FIG. 5 provides a detailed front view of an embodiment of the capping tool plug according to the present invention;

FIG. 6 provides a lateral cross-section view of an embodiment of the plug of the capping tool according to the present invention;

FIG. 7 provides a view of the front of an embodiment of the spring plate retention features according to the present invention;

FIG. 8 provides a view of the front of an embodiment of the piston and spring plate end cap retention features according to the present invention;

FIG. 9 provides a lateral cross-section view of an embodiment of the plug base and injector pins according to the present invention;

FIG. 10 provides a front view of an embodiment of the plug base and injector pins according to the present invention;

FIG. 11 provides a rear view of an embodiment of the plug base and injector pins according to the present invention;

FIG. 12 provides a side view of an embodiment of an injector pin according to the present invention;

FIG. 13 provides a cross-section view of an embodiment of the interior of an injector pin according to the present invention;

FIG. 14 provides a lateral cross-section view of an alternate embodiment of an injector pin according to the present invention;

FIG. 15 provides a lateral cross-section view of an embodiment of an injector pin mated with a pin receptacle according to the present invention;

FIG. 16 provides a lateral cross-section view of the actuation mechanism according to the present invention;

FIG. 17 provides a rear view of an embodiment of the plug according to the present invention;

FIG. 18 provides a lateral partial cross-section view of an embodiment of the capping tool and protective cap according to the present invention;

FIG. 19 provides a lateral cross-section view of an embodiment of the capping tool mated with a receptacle according to the present invention;

FIG. 20 provides a lateral cross-section view of an embodiment of the capping tool in an un-actuated state according to the present invention; and

FIG. 21 provides a lateral cross-section view of an embodiment of the capping tool in an actuated state according to the present invention.

### DETAILED DESCRIPTION

The present invention and system will now be described in more detail with reference to exemplary embodiments as shown in the accompanying drawings. While the present invention and system is described herein with reference to the exemplary embodiments, it should be understood that the present invention and system is not limited to such exemplary embodiments. Those possessing ordinary skill in the art and having access to the teachings herein will recognize additional implementations, modifications, and embodiments as well as other applications for use of the invention and system, which are fully contemplated herein as within the scope of the present invention and system as disclosed and claimed herein, and with respect to which the present invention and system could be of significant utility.

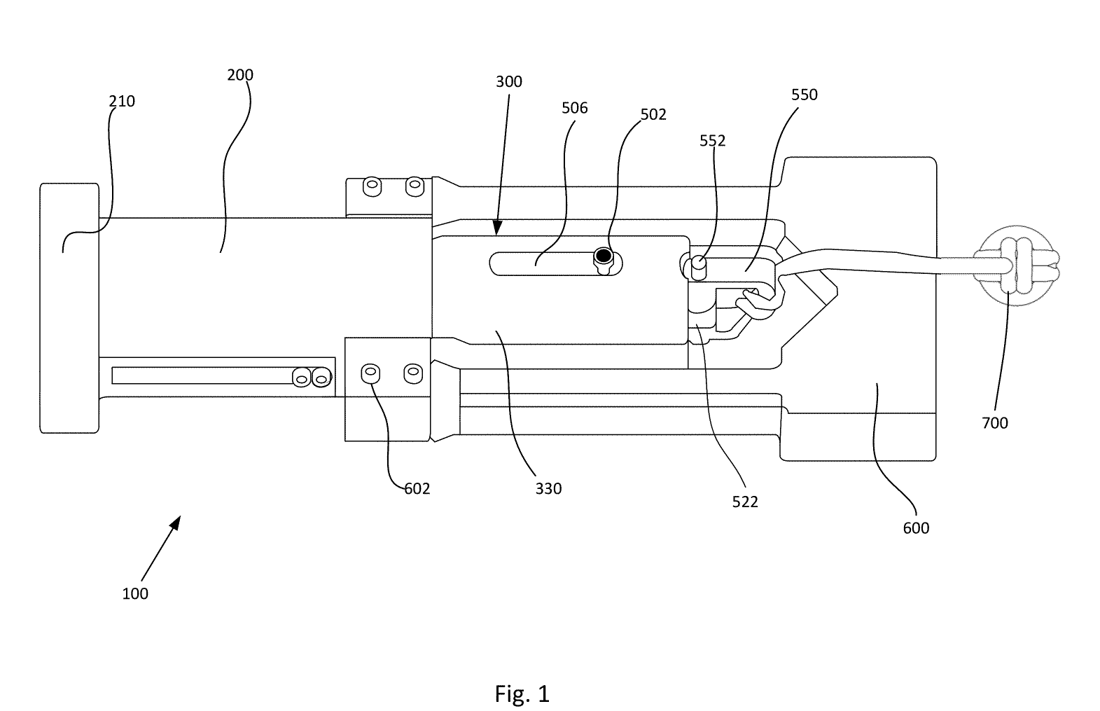

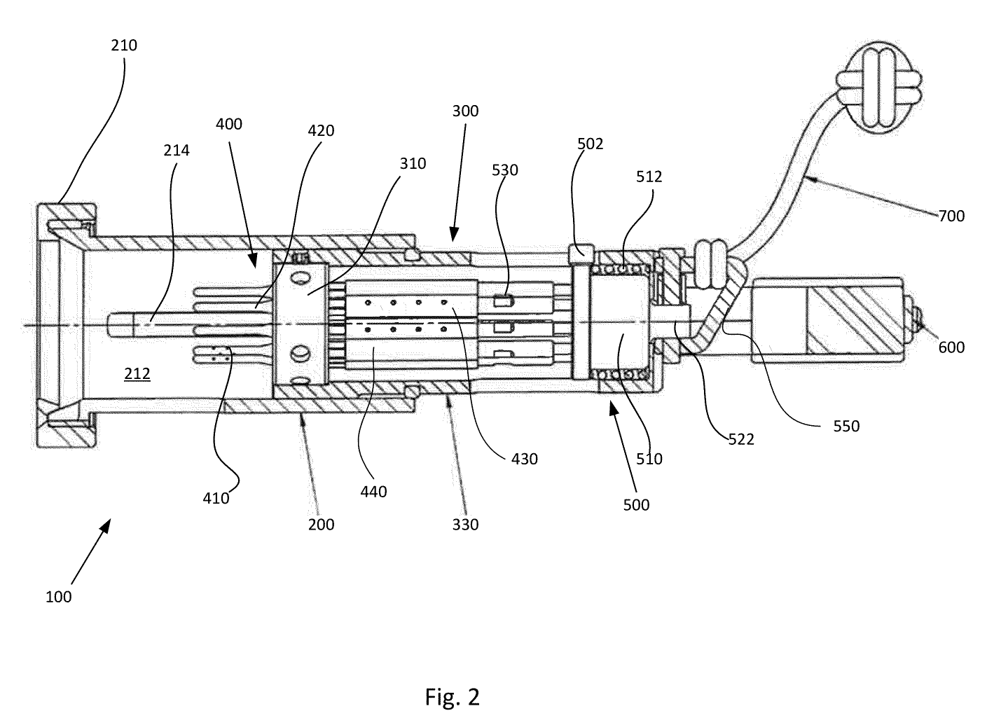

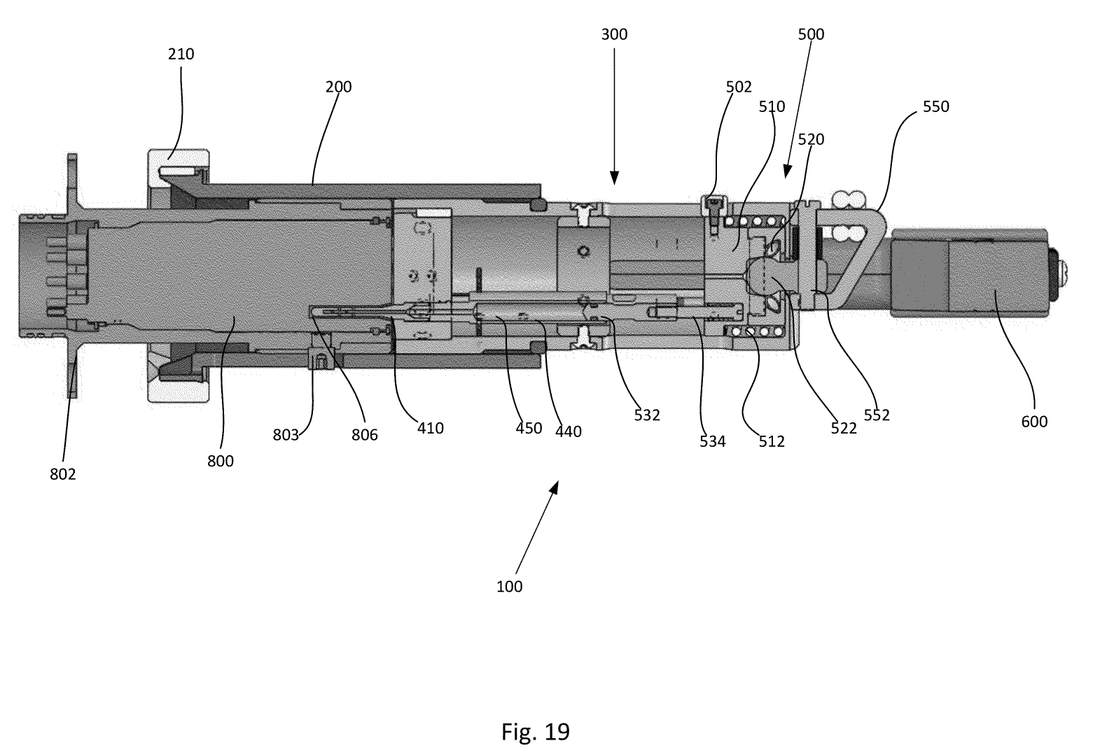

With reference now to FIG. 1, a perspective view of an embodiment of the capping tool 100 according to the present invention is provided. The capping tool 100 primarily comprises the following components: a slide 200, a plug 300, a handle 600, and grease deployment device (rope) 700. The slide 200 has a slide collar 210 and is adapted to mate with a receptacle such as receptacle 800 as shown in FIG. 19. The plug 300 is disposed at the rear of and at least partially inside the slide 200. An exemplary actuation mechanism 500 and injector pins 400, shown in FIG. 2, are disposed within the interior of the plug 300. In this example, which is not to be limiting to the invention, a shackle pin 552 secures the shackle handle 550 to the rear of the actuation pin 522. An external indicator bushing 502 indicates to the operator what state the capping tool 100 is in, either actuated or un-actuated, i.e., grease is deployed or un-deployed. The indicator bushing 502 travels in the slide alignment keyway 506 in the plug body or termination housing 330. The handle 600 is attached to the slide 200 by the hex screws 602, which also may alternatively comprise any other suitable securing means. The rope 700 is attached to the shackle handle 550 and may be used to actuate the capping tool 100.

With reference now to FIG. 2, a lateral partial cross-section view of an exemplary embodiment of the capping tool 100 according to the present invention is provided. This embodiment provides a side view of the internal components of the capping tool 100. The front portion of the capping tool comprises the slide 200 and slide collar 210. The receiving area 212 of the slide 200 is adapted to receive a receptacle for mating. The one or more latch fingers 214 retain the capping tool 100 in the mated position with a receptacle when the mating process with the receptacle is completed. The pin assembly 400 comprises a set of injector pins 410 and a set of dummy pins 420 disposed within the plug base 310. The plug base 310 is disposed at the front of the plug 300 and within the plug body 330. A set of plunger assemblies 530 are disposed on the spring plate or piston 510 and fit within the plunger tubes 430 and dummy plunger tubes 440. The indicator bushing 502 is disposed at the top of the piston 510 and moves forward upon actuation of the actuation mechanism 500. In this example, actuation of the actuation mechanism 500 is achieved by moving the actuation pin 522 to the rear by pulling on the shackle handle 550 or on the rope 700. The handle 600 of the capping tool 100 is used to maneuver and hold the capping tool 100 in position during mating with a receptacle.

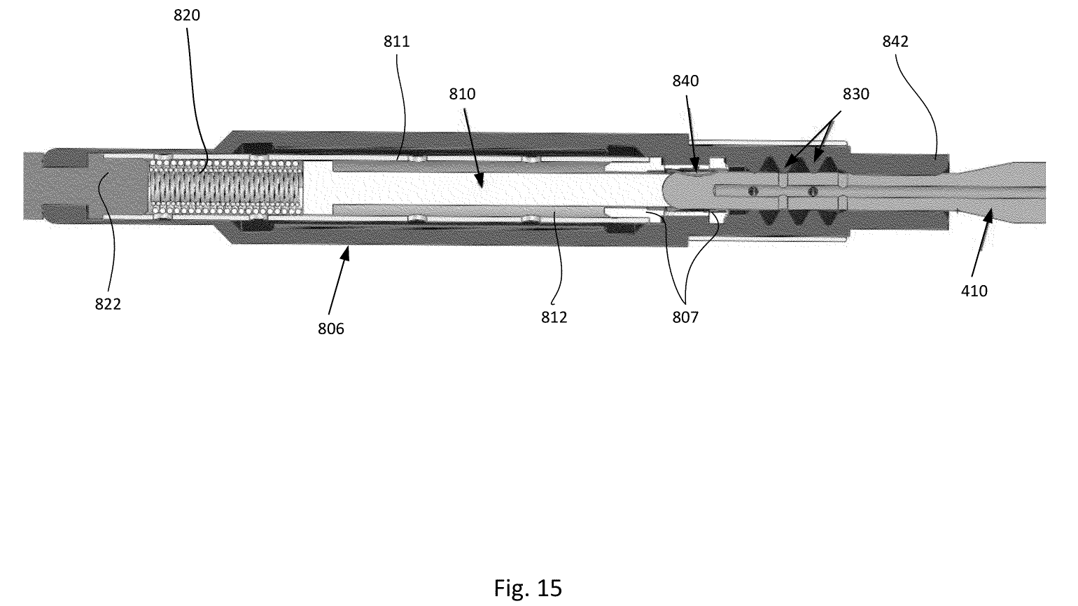

The capping tool 100 is employed to repair a damaged pin receptacle such as pin receptacle 806 of receptacle 800, shown in FIG. 19. Damage may be electrical damage caused due to performing a power-on de-mating of a subsea receptacle and plug connector. This is analogous to unplugging a refrigerator while the compressor is running, except that the receptacle and plug are at the bottom of the ocean. The resulting arc that occurs due to the power-on demating may damage or destroy the elastomeric bladder wipers 830, pin stopper 810, and/or electrical contact 840, as shown in FIG. 15.

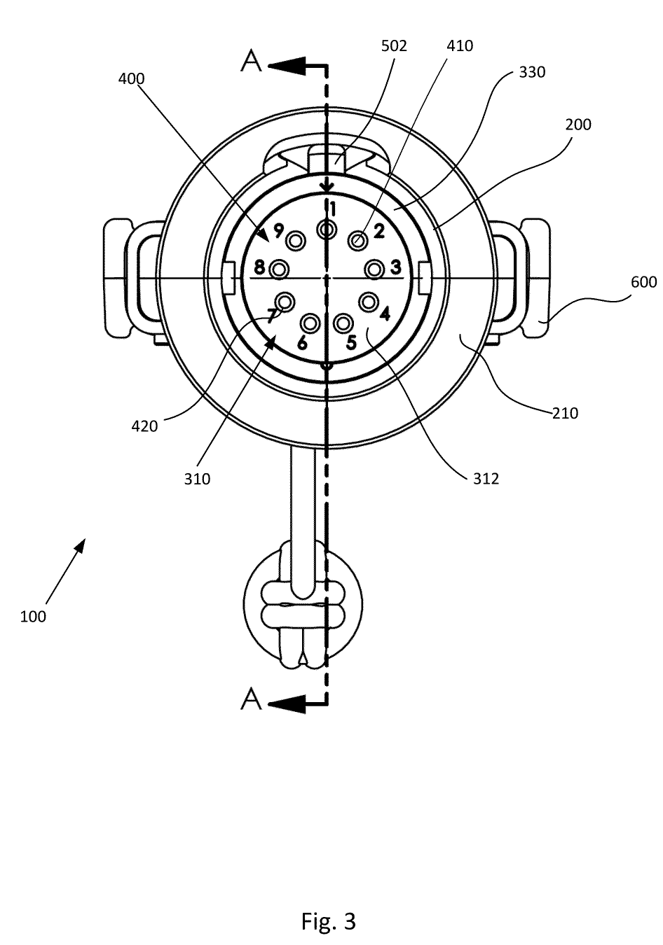

With reference now to FIG. 3, a front view of an embodiment of the capping tool 100 is provided. At the interior of the capping tool 100 is the plug base 310. The face or front 312 of the plug base 310 can be seen. Within the face 312 of the plug base 310 are disposed a pin assembly 400 that may comprise one or more injection pins 410 and dummy pins 420. The plug base 310 is disposed within the plug body 330. The plug body 330 is within the slide 200. At the front of the slide 200 is the slide collar 210, which abuts a receptacle and provides a stable base and contact point between the capping tool 100 and a receptacle for mating. The handle 600 is disposed at the rear of the capping tool 100 and may be used to maneuver the capping tool 100 (such as by an ROV or manually by a diver) into position for mating with a receptacle. The guide bushing 502 which is disposed at the rear of the capping tool 100 can be seen at the top of the plug body 330. The vertical axis A is provided to illustrate the vertical axis running from the front to the rear of the capping tool 100. For example, FIGS. 2, 6, 9, and 17-21 each provide cross-section views of embodiments the present invention or of embodiments of components used in connection with the present invention along the axis A.

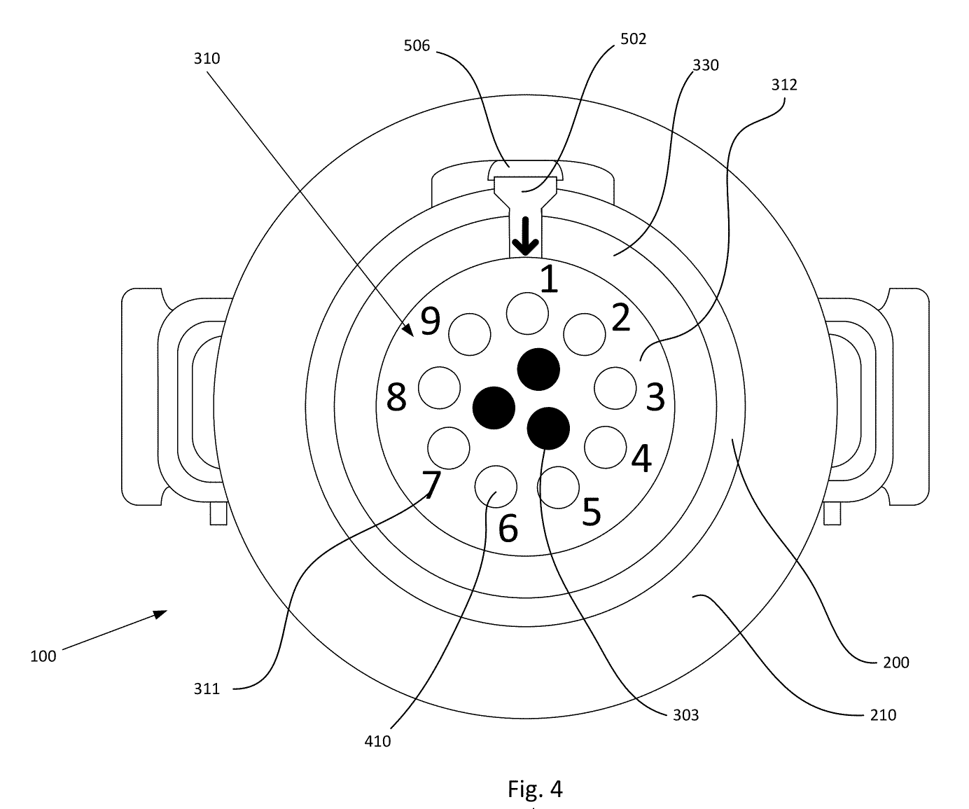

With reference now to FIG. 4, a detailed front view of an embodiment of the capping tool 100 is provided. The plug base 310 is disposed within the plug body 330 which is in turn disposed within the slide 200. A set of numbers 311 on the face 312 of the plug base 310 indicate the number associated with a particular pin in the pin assembly 400. The number 311 is used to assist in properly configuring the capping tool 100 with the receptacle to be repaired. A set of one or more pin bores 303 may be on the face 312 of the plug base 310. These bores 303 may be used to configure the capping tool 100 in a 12-pin configuration instead of the 9-pin configuration shown in FIG. 4. The slide collar 210 provides additional support for mating with a receptacle. Alignment of the capping tool 100 is performed by the slide 200 and the slide alignment keyway 506.

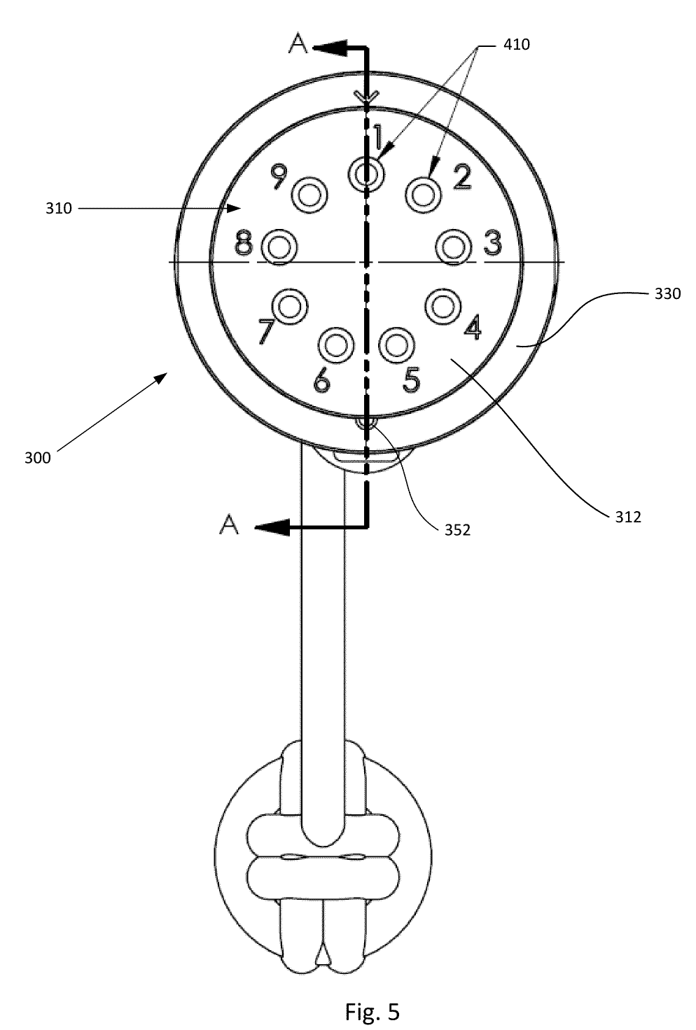

With reference now to FIG. 5, a detailed front view of an embodiment of the capping tool plug 300 is provided. The plug 300 is shown alone, although the plug 300 would typically be used in conjunction with the slide 200 and handle 600. The plug base 310 is disposed within the plug body 330. A pin assembly having injection pins 410 is disposed in the plug base 310 and extends out from the face 312 of the plug base 310. A retaining pin 352 may be used to position and secure the plug base 310 within the plug body 330 during assembly and operation.

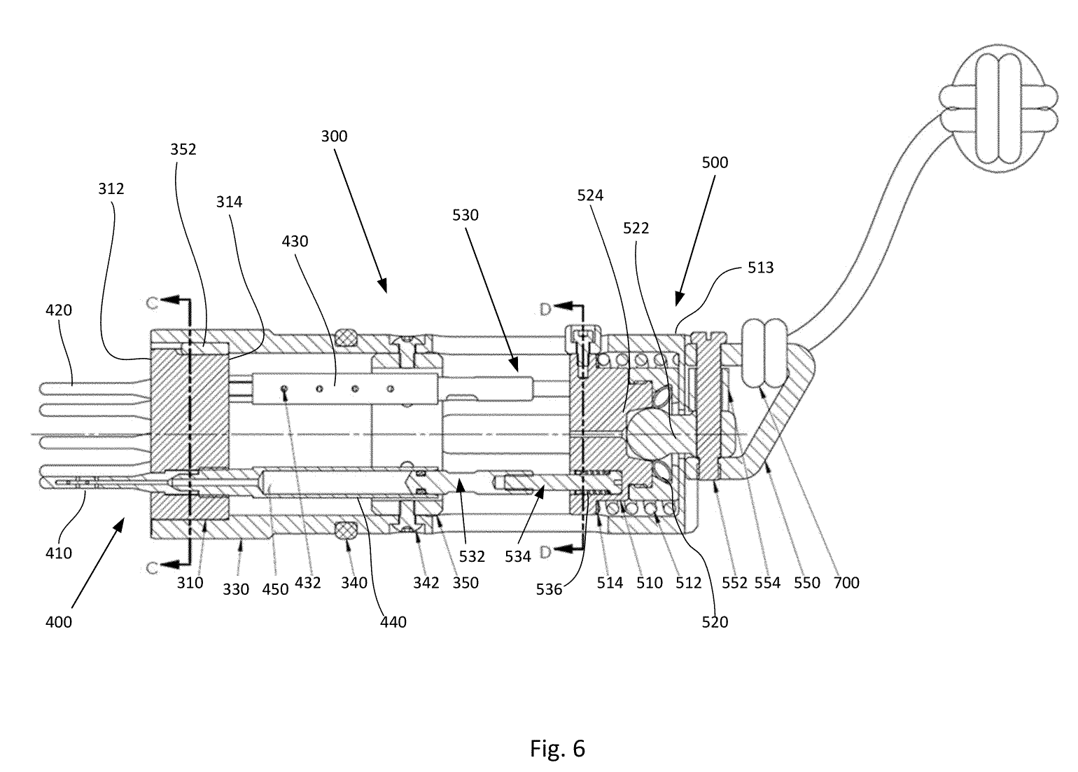

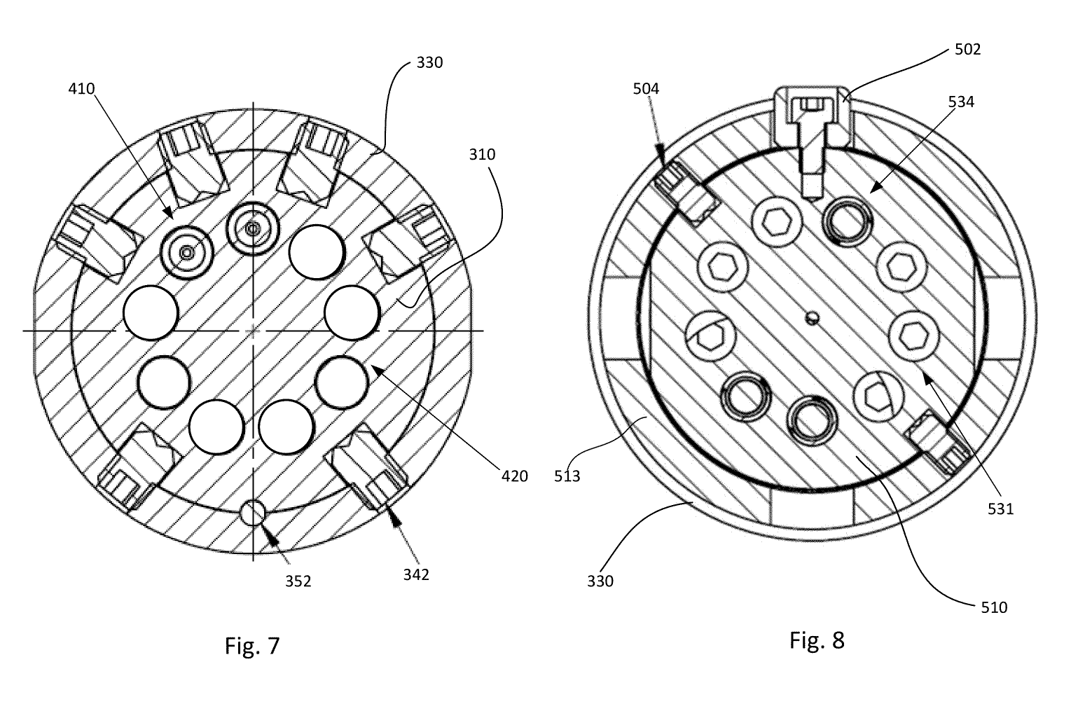

With reference now to FIG. 6, a lateral cross-section or cut-away view of an embodiment of the plug 300 of the capping tool 100 along axis A, as shown in FIG. 3, is provided. Axis C is a vertical axis at the plug base 310, and FIG. 7 is a front cross-section view of the plug base 310 along axis C. Axis D is a vertical axis at the piston 510, and FIG. 8 is a front cross-section view of the spring plate end cap 513 along axis D. FIG. 6 provides a cross-section view of the pin assembly 400, plug 300, and actuation assembly 500.

The pin assembly 400 comprises a set of one or more injection pins 410 and a set of one or more dummy pins 420. A dummy pin 420 may or may not have a dummy plunger tube 430 depending on the repair required to be performed by the capping tool 100. If a dummy pin 420 has a dummy plunger tube 430, it will also have an injector pin spring 432. The pin spring 432 is an equalization spring that provides for a more uniform back pressure on the main piston 510 during the actuation stroke to prevent the piston 510 from canting. Each injection pin 410 has a plunger tube 440 with an interior 450 adapted to contain a dielectric fluid such as dielectric grease. The pins 410 and 420 of the pin assembly 400 are disposed in the plug base 310 with the pins 410 and 420 extending out from the front 312 of the plug body 310 and the plungers 532 of the plunger assembly 530 extending from the front of the piston 510 with plunger tubes 430 and 440 intermediate the pins 410 and 420 and the plungers 532. The plug base 310 is disposed within the interior of the termination shell 330 and may be partially held in place by retaining pin 352. One or more o-rings 340 may be used to provide a seal between the plug 300 and the slide 200. The stop spacer 350 may be used to provide additional stability, support, and resilience to the plug 300 and pin assembly 400 at the point where the plungers 532 and plunger tubes 430 and 440 meet. The stop spacer 350 is held in place by one or more hex screws 342, which may also comprise any suitable retaining or securing means. The stop spacer 350 also serves as a hard stop for the forward motion of the piston 510 during actuation of the piston 510 and may serve as a safety device during the installation/assembly process for the capping tool 100 while the piston spring 512 is being armed. As a safety, the stop spacer 350 prevents the piston 510 from exiting the front of the capping tool 100 and causing injury or damage.

The plunger assembly 530 is disposed at the front of the piston 510. Actuation of the piston 510 is performed by moving the actuation pin 522 rearward. The actuation pin 522 is held by the actuation pin spring 520 in the actuation pin opening 524 of the piston 510 against the biasing force of the piston spring 512. Moving the actuation pin 522 rearward moves the pin out of the actuation pin opening 524 and against the biasing and retaining force of the actuation pin spring 520. Actuation of the actuation mechanism 500 begins after sufficient force has been applied to the actuation pin 522 to move it past the actuation pin spring 520 and out of the actuation pin opening 524. The biasing force of the piston spring 512 then moves the piston 510 forward within the plug body 330, causing the plunger assembly 530 to move forward within the plunger tubes 430 and 440. This forward motion of the plunger assembly 530 both compresses and moves dielectric fluid through the interior 450 of the injector plunger tube 440 and out through the injector pin 410. Actuation may be initiated by applying a rearward force to the shackle handle 550 which is attached to the actuation pin 522 by the shackle pin 552, or by applying a force to the rope 700. A spring shim 514 protects the piston 510 from wear caused by movement of the piston spring 512. The spring shim 514 also decouples the piston spring 512 from the piston 510 so that when the piston spring 512 rotates under a spring compression force it does not also apply a torque or rotational force to the piston 510.

With reference now to FIG. 7, a view of the front of an embodiment of the plug base 310 retention features at the axis C, shown in FIG. 6, is provided. The plug base 310 is disposed within the termination shell 330 and is held in place by one or more hex screws 342, which may be hex screws or any other suitable securing means for radially securing a device within the termination shell 330, and retaining pin 352. One or more injector pins 410 and dummy pins 420 may be disposed around an inner circumference of the pin body 310.

With reference now to FIG. 8, a view of the front of an embodiment of the piston 510 and spring plate end cap 513 retention features at the axis D, shown in FIG. 6, according to the present invention is provided. The spring plate end cap 513 is disposed within the plug body 330 and may be guided or temporarily or permanently affixed using one or more hex screws 504. The guide bushing 502 is disposed at the top of the piston 510 and is used to provide an indication to an operator of the state of the capping tool 100, either actuated or un-actuated. One or more plunger rods 534 may be secured in the piston 510, and positions on the piston 510 un-occupied by plunger rods may be filled with hex screws 531 or other suitable means.

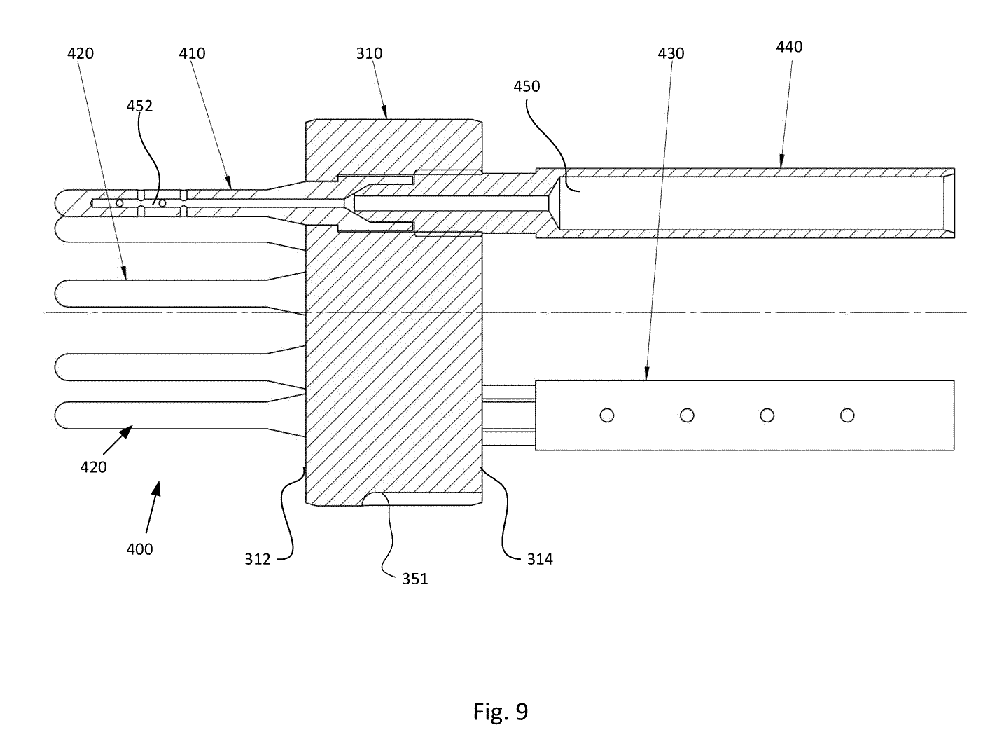

With reference now to FIG. 9, a lateral cross-section view of an embodiment of the plug base 310 and pin assembly 400 is provided. The indentation 351 in the plug base 310 is adapted to receive a retaining pin 352, shown in FIG. 7, to secure the plug base 310 within the plug body 330 of the plug 300. The pin assembly 400 comprises both injector pins 410 and dummy pins 420. The dummy pins 410 may or may not have dummy pin plunger tubes 430 affixed to the rear of the dummy pins 420 at the back 314 of the plug base 310. A dummy pin 420 requires a dummy pin plunger tube 430 and injector pin spring 432, shown in FIG. 2, if the dummy pin 420 is opposite an injector pin 410 on the face 312 of the plug base 310. The opposing injector pin plunger tubes 440 and dummy pin plunger tubes 430 with injector pin springs 432 provide a balanced resistance for the forward motion of the piston 510, shown in FIG. 2, so that the piston 510 does not cant during actuation. Each injector pin 410 has an injector pin plunger tube 440 which comprises an injector pin interior 450. The interior 450 is adapted to contain a dielectric fluid or grease used to stop or repair an electrical short in a receptacle. The dielectric fluid is expelled through dielectric fluid guides 452 in the injector pins 410 into the damaged receptacle. During actuation of the spring, piston and plunger rods, back pressure is experienced and applied from the damping force of the grease being pushed out of the injector pins 410. In certain conditions it is possible that this force may cause the piston 510 to cant slightly, which may lead to the piston becoming stuck in the termination shell/plug body 330 prior to completing the injection of grease into the receptacle. By placing one (or more) dummy plunger tube, spring, and plunger directly opposite the grease injector plunger and tube assembly (or as opposite as possible), the dummy plunger/tube assembly can help mitigate the cant in the piston 510 and avoid it becoming stuck. By having the dummy tube opposite the injector plunger/tube assembly, the driving force of the spring is substantially uniform as applied to the piston 510.

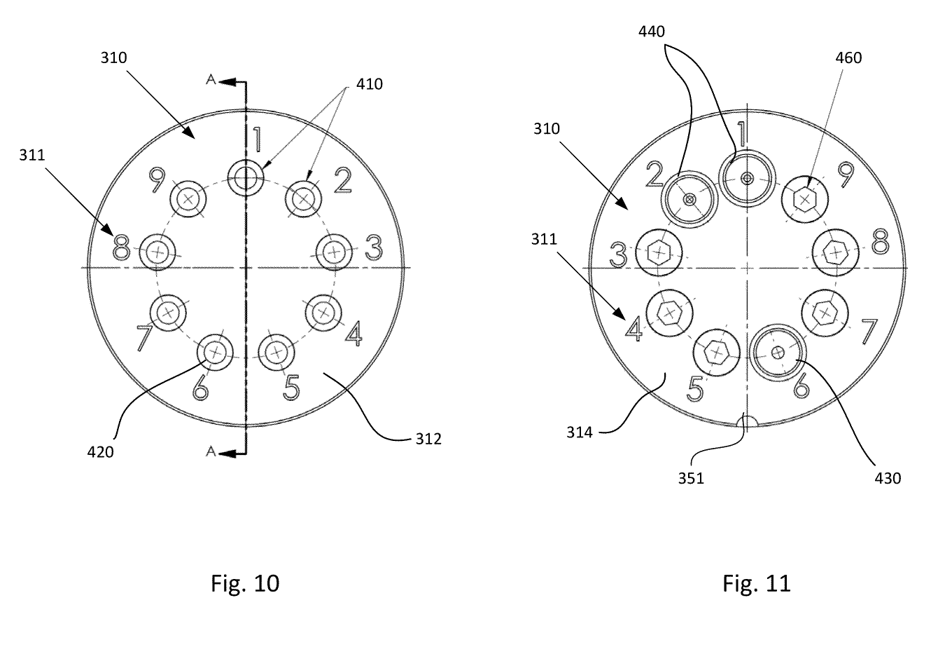

With reference now to FIG. 10, a front view of an embodiment of the plug base 310 and pin assembly 400 is provided. Disposed along an interior circumference of the front 312 of the plug base 310 are one or more injector pins 410 and dummy pins 420. The numbers 311 indicate the position of each of the pins 410 and 420.

With reference now to FIG. 11, a rear view of an embodiment of the plug base 310 and injector pins 400 is provided. Disposed along an interior circumference of the back 314 of the plug base 310 are one or more injector pin plunger tubes 440 and dummy pin plunger tubes 430. Positions indicated by numbers 311 not occupied by a plunger tube 430 or 440 are filled with hex screws 460 securing dummy pins 420 not requiring a plunger tube.

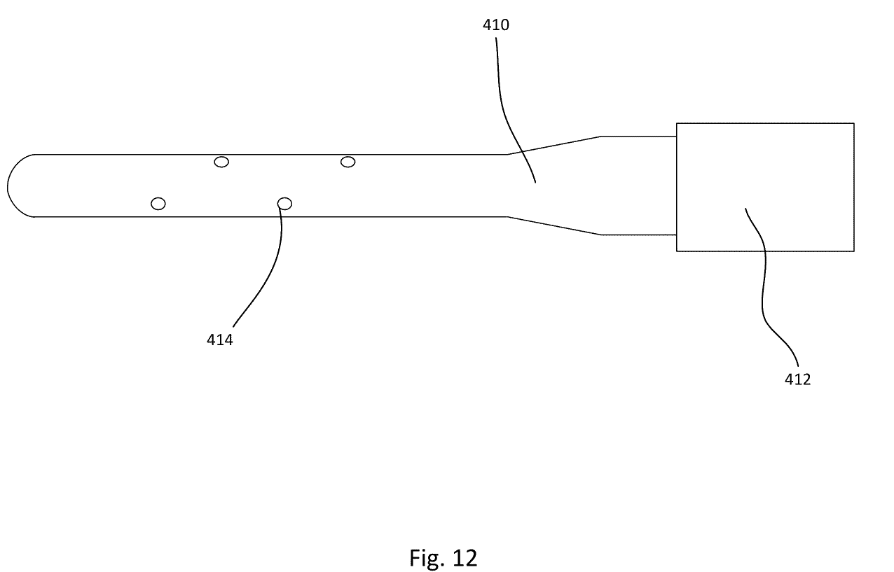

With reference now to FIG. 12, a side view of an embodiment of an injector pin 410 is provided. The pin 410 is disposed at the front 312 of the plug base 310 as seen in FIG. 9. The base 412 of the pin 410 is disposed within the plug base 310 and is adapted to receive the plunger tube 440. One or more dielectric fluid openings 414 on the pin 410 provide channels for dielectric fluid or grease to exit the injector pin 410.

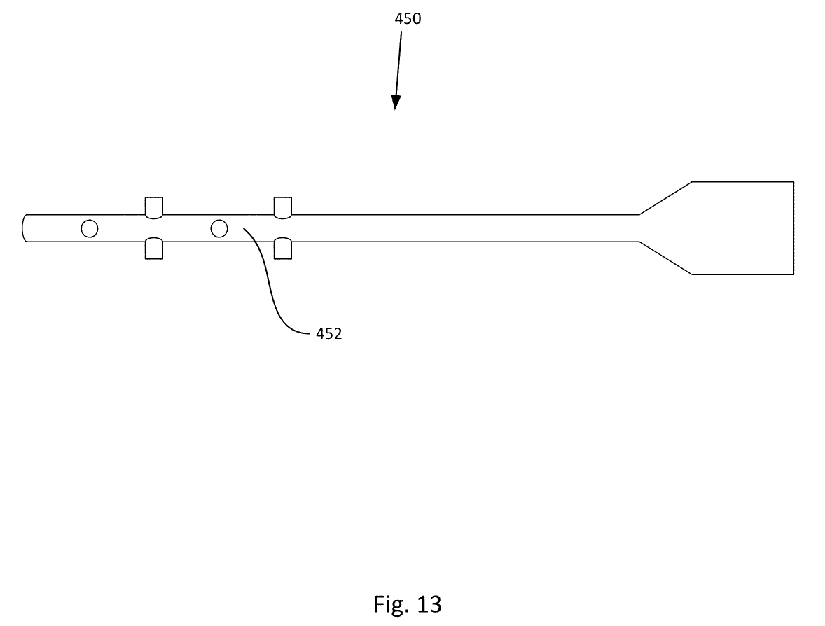

With reference now to FIG. 13, a cross-section view of an embodiment of the interior 450 of an injector pin 410 according to the present invention is provided. The interior 450 may be the interior of an injector pin 410 as shown in FIG. 12. The interior 450 has one or more dielectric fluid channels 452 disposed at the top, bottom, and sides of the injector pin interior 450 to provide channels or paths for dielectric fluid to exit the interior 450.

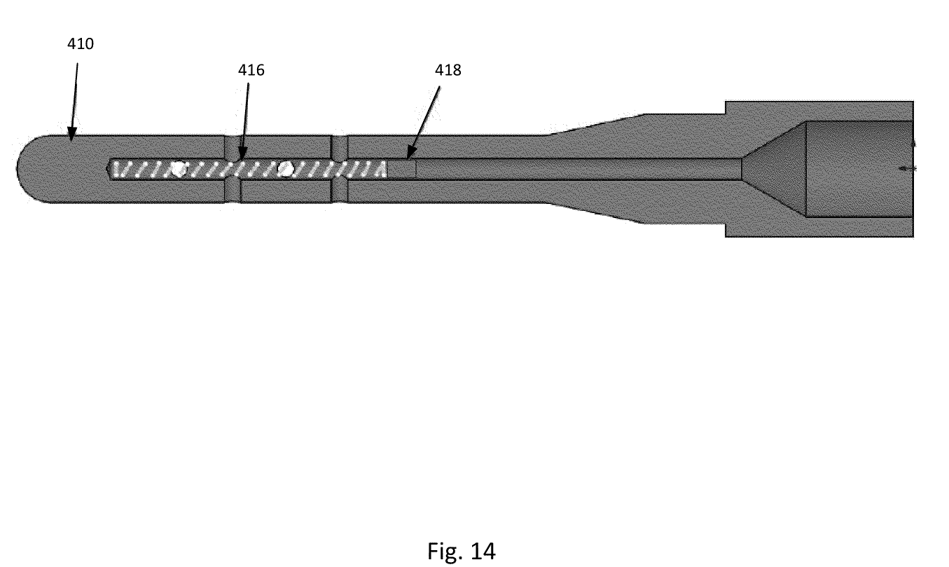

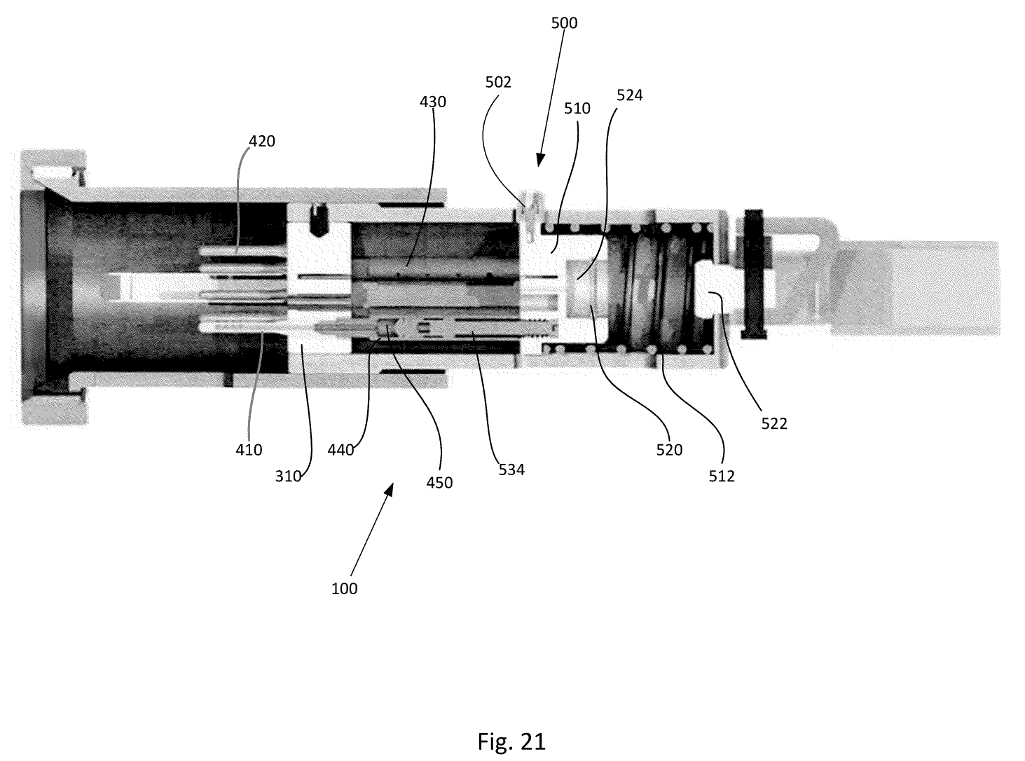

With reference now to FIG. 14, a lateral cross-section view of an alternate embodiment of an injector pin 410 according to the present invention is provided. The dielectric grease or fluid used for repairing a damaged receptacle is both thick and water insoluble and in most applications will stay within the injector pin 410 and not mix with exterior seawater. However, if different dielectric grease were used, or if conditions subsea were particularly turbulent, a pin seal 418 may be used in the injector pin 410. The pin seal 418 is held in place by pin seal spring 416, preventing any dielectric grease from escaping the pin 410 and preventing any exterior fluids or matter from entering the pin 410 and mixing with the fluid. When the dielectric grease is forced out of the pin 410 by a plunger piston 532 as seen in FIG. 21, the pressure compresses the pin seal 418 against the biasing force of the pin seal spring 416, forcing the pin seal 418 forwards and opening the path for the dielectric grease to exit openings formed in the pin 410.

With reference now to FIG. 15, a lateral cross-section view of an embodiment of an injector pin 410 mated with an exemplary pin receptacle 806 of a type potentially in need of repair in the field is provided. The injector pin 410 enters the pin receptacle 806 through an opening formed in the front 842 of the pin receptacle 806. The front 842 of the pin receptacle 806, in this example, is sealed by pin stopper 810, which is held in a forward position by the biasing force of the stopper spring 820. The stopper base 822 seals the rear of the pin receptacle 806 and secures the receptacle stopper housing 811 to the pin receptacle 806. An interior cavity 812 is typically filled with dielectric grease. However, if the pin receptacle 806 becomes damaged through wear, electric short, arc flash, or through any other event, the cavity 812 may become filled with seawater. Damage may cause a short at the electrical contact 840, which may short through either the seawater or against the stopper guides 807. The bladder wipers 830 normally wipe the end of an entering electrical termination so that a clean contact may be made with the electrical contact 840, however, if damage has occurred the wipers 830 may no longer form a proper seal allowing seawater into the pin receptacle 806. When the injector pin 410 fully enters into the pin receptacle 806, dielectric grease is injected into the bladder wipers 830 of the pin receptacle 806 from the injector pin 410. This grease purges any seawater in the pin receptacle 806 and may also insulate the electrical contact 840 against short through the seawater, interior housing 812, stopper guides 807, or other portions of the electrical contact 840. The grease need only enter the pin receptacle 806 as far as the bladder wipers 830 and electrical contact 840 to prevent an electrical short. However, damage will not occur if the dielectric grease also fills the cavity 812.

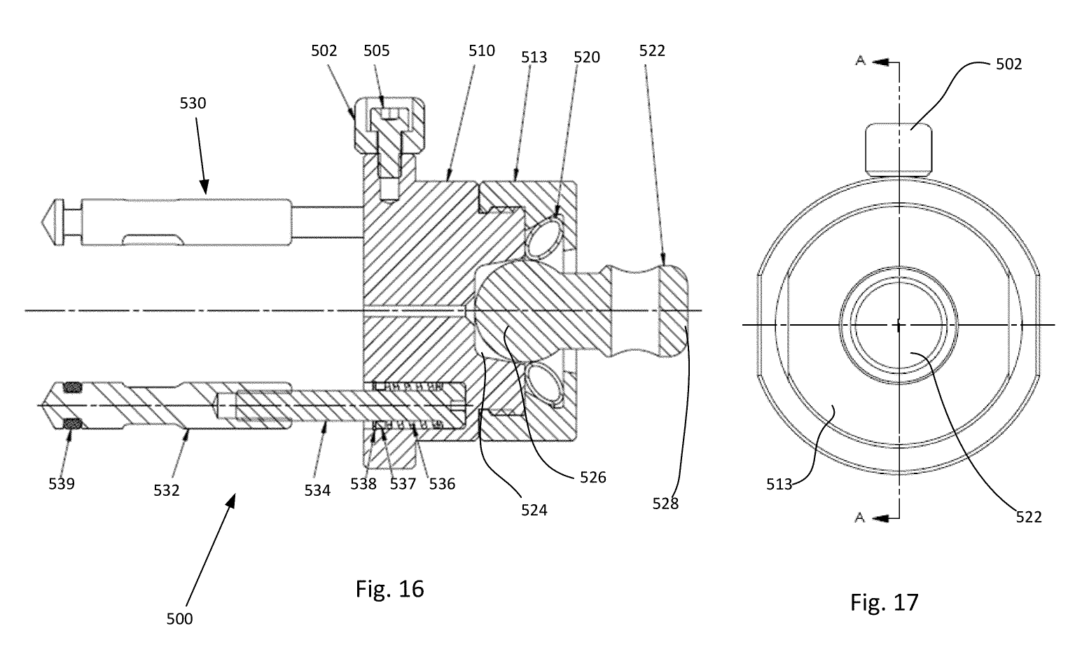

With reference now to FIG. 16, a lateral cross-section view of the actuation mechanism 500 is provided. The actuation mechanism 500 comprises the plunger assembly 530, piston 510, and actuation pin 522. The plunger assembly 530 is disposed at the front of the piston 510. Each plunger in the plunger assembly 530 has, for example, a plunger piston 532 at the end of a plunger rod 534. The plunger piston 532 fits within a plunger tube such as dummy plunger tube 430 or injector pin plunger tube 440 shown in FIG. 9. An o-ring 539 creates a seal within the plunger tube 440 to force the dielectric grease out through the injector pin 410. The plunger rod 534 is biased against the piston 510 by the compression spring 536, which is held in place by spring spacer 537 and spring retaining ring 538. This spring 536 provides a biasing and suspension force during filling of the injector pin plunger tubes 440 with dielectric grease. The spring 536 also may provide for pressure compensation of a plunger tube 440, shown in FIG. 9. If the pin holes 414, shown in FIG. 12, were to become blocked, the spring 536 provides for the dielectric grease to compress under hydrostatic pressure instead of crushing the plunger tube 440. The indicator bushing 502 secured to the piston 510 by the hex screw 505 indicates the position of the piston 510 within the plug body 330 of the plug 300. Actuation of the actuation mechanism 500 occurs when then actuator pin 522 is pulled rearward out of the actuator pin opening 524 and past the actuator seal spring 520. The actuator seal spring 520 holds the actuator pin 522 in place as is secured between the piston 510 and the spring plate end cap 513. The actuator seal spring 520 may be a canted coil spring, or Bal Seal spring, in a latching configuration. The spring 520 and angled geometry of the spring 520 allow for the actuator pin 522 to be disengaged by pulling rearward on the actuator pin 522 within a 20 degree force cone. This force cone is necessary as the force may be applied by an ROV, which may lack fine motor skill. The end cap 513 is threaded onto the piston 510 to secure and protect the spring seal 520. When the actuation pin 522 is moved out of the pin opening 524 and out of the seal spring 520, the biasing force of the piston spring 512, shown in FIG. 6, moves the piston 510 forward, causing the plunger piston 532 to expel the dielectric grease out of the plunger 440 and through the injector pin 410.

With reference now to FIG. 17, a rear view of an embodiment of the plug 300 according to the present invention is provided. The spring plate end cap 513 holds the seal spring 520, shown in FIG. 16, in place against the piston 510. The actuator pin 522 may be moved rearward to actuate the actuation mechanism 500. The indicator bushing 502 may be used to move the piston 510 within the plug body 330, shown in FIG. 2, and also serves to indicate the state of the actuation mechanism 500 as either being in an actuated or un-actuated state.

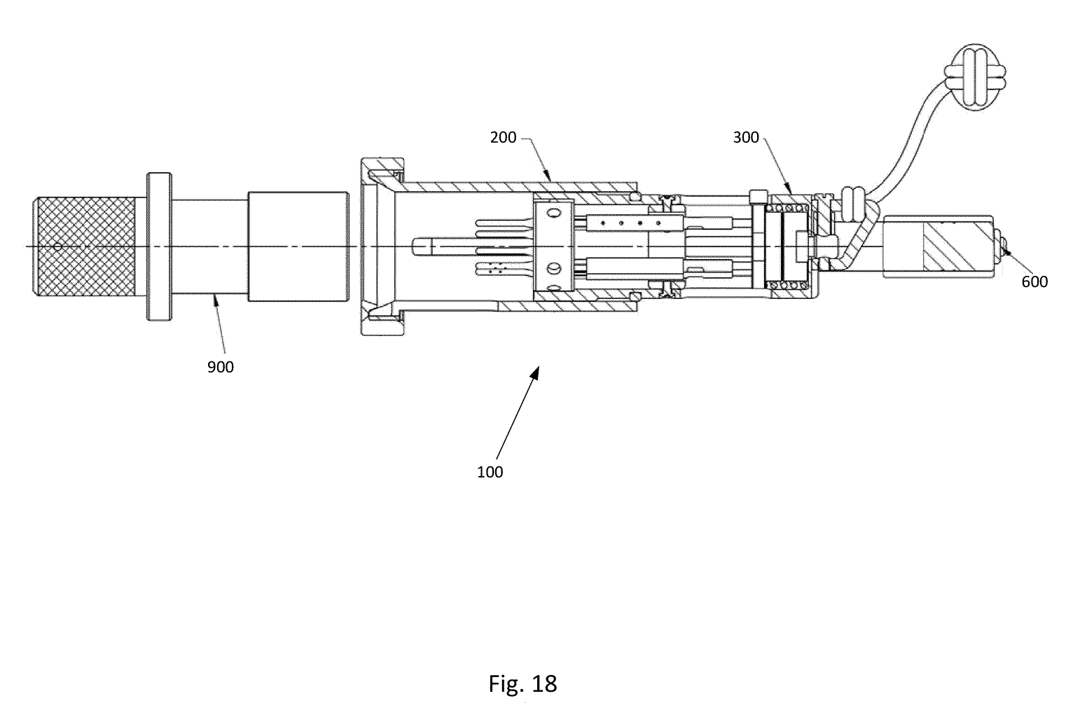

With reference now to FIG. 18, a lateral partial cross-section view of an embodiment of the capping tool 100 and protective cap 900 according to the present invention is provided. The protective end cap 900 may be inserted into the slide 200 to protect the end of the plug 300 when the capping tool 100 is not mated to a receptacle. The handle 600 is oversized and shaped such that it can easily be operated by an ROV.

With reference now to FIG. 19, a lateral cross-section view of an embodiment of the capping tool 100 mated with a receptacle 800 according to the present invention is provided. The receptacle 800 may be a Nautilus type receptacle connector and more specifically may be a bulkhead receptacle connector. The receptacle 800 may have a pin receptacle 806 configuration comprising 4, 6, 7, 8, 9, 12, 19, or any other necessary numerical configuration, pin receptacles 806. The capping tool 100 is employed to inject a dielectric grease into a damaged pin receptacle 806. The dielectric grease insulates the pin receptacle 806 from an electrical short in the receptacle 800. The short may have been caused by removing a connector, from an arc flash, or from debris or other material subsea. The capping tool 100 is used in place of bringing the entire subsea structure to which the receptacle 800 is attached to the surface for repair, a costly and time consuming procedure. The capping tool 100 is placed on the receptacle 800 to insulate the pin receptacle 806 against the short. This may be in connection with switching circuits to repair the connection or to protect the receptacle 800 until it can be repaired or replaced.

The receptacle 800 typically has two or more sets of redundant circuits and is deployed with a redundant receptacle also having two or more redundant circuits. This multiple redundancy reduces the likelihood of having to bring a subsea structure to the surface for repair in the event of damage to or failure of a receptacle 800.

The capping tool 100 is moved into place by the handle 600. The slide collar 210 is positioned about the exterior of the receptacle 800 and when fully mated, the slide collar 210 will abut the receptacle base 802. The slide 200 may be correctly aligned with the receptacle 800 by the alignment bushing 803 and keyways 506 and secured by one or more latch fingers 214, shown in FIG. 4. The injector pin 410 is inserted into the pin receptacle 806, and when fully mated, the actuation mechanism 500 may be actuated by applying a rearward force on the actuation pin 522. When fully mated, the latch fingers 214, shown in FIG. 2, engage with the receptacle 800 to secure the capping tool 100 to the receptacle 800. The actuation pin 522 may be removed from the seal spring 520 by pulling on the shackle handle 550 which is attached to the actuation pin 522 by the shackle pin 552. When the actuation pin 522 is removed, the piston 510 is moved forward by the biasing force from the piston spring 512. The forward motion moves the plunger rod 534 and attached plunger piston 532 forward with the piston 510. The plunger piston 532 moves through the interior 450 of the injector pin plunger tube 440. The interior 450 holds dielectric grease that will be used to insulate any short or damage in the pin receptacle 806. The plunger 532 travels forward through tube 440 expelling the dielectric grease out through the injector pin 410 into the pin receptacle 806, purging any intruding seawater and insulating any electrical short in the pin receptacle 806.

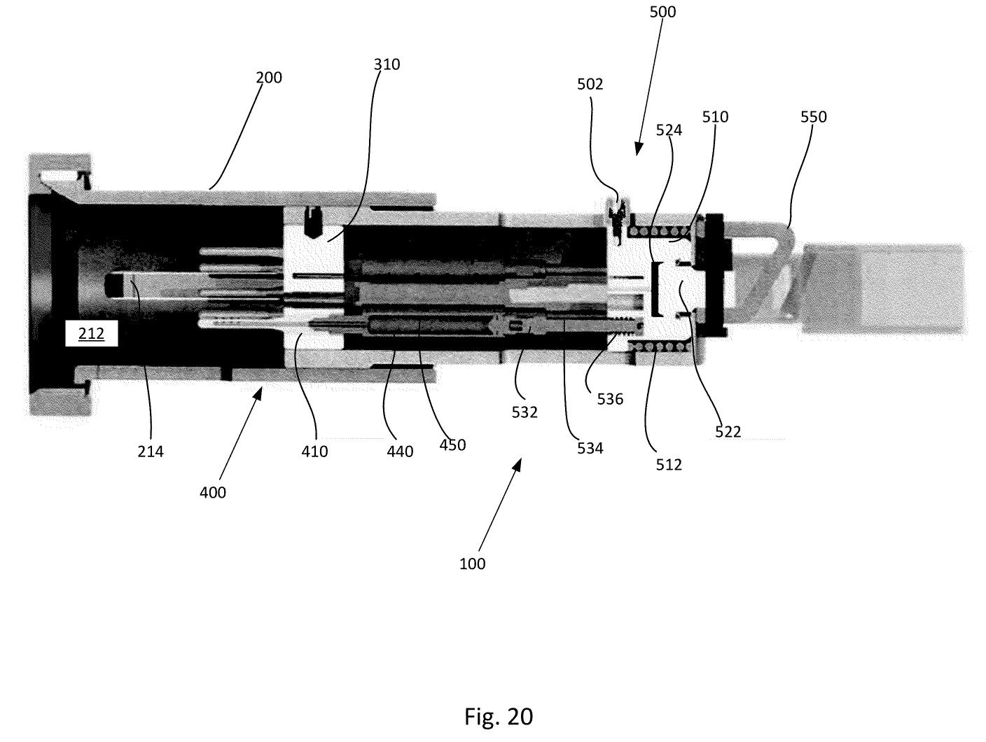

With reference now to FIG. 20, a lateral cross-section view of an embodiment of the capping tool 100 in an un-actuated state according to the present invention is provided. FIG. 21 provides a lateral cross-section view of an embodiment of the capping tool 100 in an actuated state. FIGS. 20 and 21 show how the internal components of the actuation mechanism 500 move within the capping tool as it is actuated. A receptacle, such as receptacle 800 in FIG. 19, may be in the receiving area 212 of the slide 200 and secured on the pin assembly 400 by the latch finger 214. The rearward position of the indicator bushing 502 indicates that the actuation mechanism 500 is in an un-actuated state and is ready to inject dielectric grease. When the actuation pin 522 is removed from the actuation pin opening 524 by a rearward force on the shackle handle 550, the piston 510 is moved forward by the biasing force of the piston spring 512. The forward movement of the piston 510 causes the plunger assembly 530 to move forward within the interior 450 of the plunger tube 440 towards the plug base 310. Dielectric fluid in the interior 450 of the plunger tube 440 is forced out of the front of the injector pin 410 by the forward motion of the plunger assembly 530.

With reference now to FIG. 21, a lateral cross-section view of an embodiment of the capping tool 100 in an actuated state according to the present invention is provided. The actuation pin 522 is shown out of the actuation pin opening 520 as the piston 510 has been moved forward towards the plug base 310 by the piston spring 512. The seal spring 524 that held the actuation pin 522 in the actuation pin opening 524 can be seen in the piston 510. The piston 510 has moved the plunger assembly 530 fully into the interior 450 of the plunger tube 440 and any dielectric grease that was in the plunger tube 440 would have been expelled through the injector pin 410. An assembly similar to plunger assembly 430 would have moved within the dummy pin plunger tube 430 attached to dummy pin 420. The indicator bushing 502 in a forward position indicates that the capping tool's 100 actuation mechanism 500 has been actuated.

While the invention has been described by reference to certain preferred embodiments, it should be understood that numerous changes could be made within the spirit and scope of the inventive concept described. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

1. A field deployable connector repair device for mating with a damaged undersea connector, the connector repair device comprising:
a plug unit having a cylindrical body, a rear end and a front end adapted for mating engagement with a damaged receptacle unit when aligned with a plug receiving end of the damaged receptacle unit, the plug body housing a set of at least one fluid injection pin and a set of at least one fluid plunger configured in receiving alignment with the set of at least one injection pin and mounted to a piston, the piston being slidably mounted in the plug unit body, a spring actuation mechanism adapted to actuate the piston from a pre-deployed position to a deployed position and to propel the piston forward from the rear end toward the front end of the plug unit and propel the set of at least one plunger to force dielectric fluid through and out of the set of at least one fluid injection pin; and
an alignment means for aligning the plug unit with the damaged receptacle such that the set of at least one injector pin is disposed opposite a set of at least one pin receptacle contained in the damaged receptacle unit in a desired manner, whereby upon mating the plug unit with the damaged receptacle unit and upon actuating the spring actuation mechanism the set of at least one injection pin is received into the set of at least one pin receptacle, the piston acts on the set of at least one plunger and the dielectric fluid is injected through the set of at least one fluid injection pin and into the set of at least one pin receptacle contained in the damaged receptacle unit; and
a locking mechanism adapted to lock the plug in a mated position with the damaged receptacle unit.

2. The connector repair device of claim 1 further comprising a cylindrically-shaped slide member partially surrounding the plug body and the set of at least one fluid injection pin and having a slide collar at an end distal to the plug rear end, the slide collar being configured to facilitate bringing the plug unit into alignment and engagement with the damaged receptacle unit during the mating process.

3. The connector repair device of claim 1 further comprising a means for deploying the spring actuation means external to the plug unit.

4. The connector repair device of claim 3 wherein the means for deploying the spring actuation means is a shackle device having a pin connected to an external release mechanism.

5. The connector repair device of claim 1 further comprising a set of at least one dummy pin.

6. The connector repair device of claim 5 further comprising a plug pin assembly end adapted to fix the set of at least one fluid injection pin and the set of at least one dummy pin in a defined pattern, and a means for releasably mounting the set of at least one fluid injection pin and the set of at least one dummy pin within the plug unit.

7. The connector repair device of claim 1 wherein the set of at least one fluid injection pin each includes a body having at least one opening through which the dielectric fluid exits the body when a plunger is acted on by the piston.

8. The connector repair device of claim 1 wherein the locking mechanism is further adapted to lock the plug in a mated position with the damaged receptacle unit and to release the plug from the damaged receptacle in a de-mating operation.

9. The connector repair device of claim 1 wherein each of the set of at least one plunger includes a seal to prevent leakage of the dielectric fluid upon actuation.

10. The connector repair device of claim 1 further comprising a terminal tube portion disposed intermediate each respective set of at least one fluid injection pin and set of at least one plunger, and which contains the dielectric fluid.

11. A field deployable connector repair device for mating with a damaged undersea connector, the connector repair device comprising:
a plug unit having a body, a rear end and a front end adapted for mating engagement with a damaged receptacle unit when aligned with a plug receiving end of the damaged receptacle unit, the plug body housing a first fluid injection pin and a first fluid plunger associated with the first fluid injection pin and mounted to a piston, the piston being movably mounted in the plug unit body, a means to maintain the first plunger in a pre-deployed position, and an actuation mechanism adapted to actuate the piston from the pre-deployed position to a deployed position and to propel the piston forward from the rear end toward the front end of the plug unit and propel the first plunger to force dielectric fluid through and out of the first fluid injection pin; and
an alignment means for aligning the plug unit with the damaged receptacle such that the first fluid injector pin is disposed opposite a first pin receptacle in the damaged receptacle unit in a desired manner, whereby upon mating the plug unit with the damaged receptacle unit and upon actuating the actuation mechanism the first injection pin is received into the first pin receptacle, the piston acts on the first plunger and the dielectric fluid is injected through the first fluid injection pin and into the first pin receptacle contained in the damaged receptacle unit; and
a means for releasably locking the plug in a mated position with the damaged receptacle unit.

12. The connector repair device of claim 11 further comprising a cylindrically-shaped slide member partially surrounding the plug body and the first fluid injection pin and having a slide collar at an end distal to the plug rear end, the slide collar being configured to facilitate bringing the plug unit into alignment and engagement with the damaged receptacle unit during the mating process.

13. The connector repair device of claim 11 further comprising a means for deploying the spring actuation means external to the plug unit.

14. The connector repair device of claim 13 wherein the means for deploying the spring actuation means is a shackle device having a pin connected to an external release mechanism.

15. The connector repair device of claim 11 further comprising a first dummy pin.

16. The connector repair device of claim 15 further comprising a plug pin assembly end adapted to fix the first fluid injection pin and the first dummy pin in a defined pattern, and a means for releasably mounting the first fluid injection pin and the first dummy pin within the plug unit.

17. The connector repair device of claim 11 wherein the first fluid injection pin includes a body having at least one opening through which the dielectric fluid exits the body when the first plunger is acted on by the piston.

18. The connector repair device of claim 11 wherein the locking mechanism is further adapted to lock the plug in a mated position with the damaged receptacle unit and to release the plug from the damaged receptacle in a de-mating operation.

19. The connector repair device of claim 11 wherein the first plunger includes a seal to prevent leakage of the dielectric fluid upon actuation.

20. The connector repair device of claim 11 further comprising a first terminal tube portion disposed intermediate the first fluid injection pin and the first plunger, and which contains the dielectric fluid.
